(19) United States
(12) Patent Application Publication
(10) Pub. No.: US 2013/0226693 A1
(43) Pub. Date: Aug. 29, 2013

(54) Allocating Deals to Visitors in a Group-Buying Service

(71) Applicants: Tao Qin, Beijing (CN); Tie-Yan Liu, Beijing (CN); Wei-Ying Ma, Beijing (CN)

(72) Inventors: Tao Qin, Beijing (CN); Tie-Yan Liu, Beijing (CN); Wei-Ying Ma, Beijing (CN)

(73) Assignee: MICROSOFT CORPORATION, Redmond, WA (US)

(21) Appl. No.: 13/407,762

(22) Filed: Feb. 29, 2012

(51) Int. Cl. G06Q 10/04; G06Q 30/02

(52) U.S. Cl. 705/14.46; 705/14.72; 705/14.69

(57) ABSTRACT

Functionality is described herein for allocating group-buying deals in a group-buying service. In certain implementations, the functionality operates by receiving deal information from deal-providing entities (such as merchants). The deal information describes plural deals. The functionality then assigns a number of impressions to each deal so as to maximize revenue provided to an entity which administers the group-buying service. This yields allocation information. The functionality then presents deals to users in accordance with the allocation information. For example, if the allocated number of impressions for a certain deal is x, then the functionality will provide x opportunities for users to select this deal.

### BACKGROUND

A group-buying service offers contingent discounts on items. In a typical manner of operation, a representative of the group-buying service negotiates with a merchant regarding the terms of a group-buying deal. After reaching agreement, the group-buying service posts the deal on its website. The deal typically offers users an item for a stated discount price, providing that a prescribed number of users accept the deal. This means that no user receives the item at the discounted price if fewer than the prescribed number of users has accepted the deal at the end of a prescribed period of time.

Group-buying services have enjoyed considerable success in recent years. Nevertheless, there remains room for improvement in the manner in which the group-buying services implement and administer the group-buying paradigm.

### SUMMARY

Functionality is described herein for allocating grouping-buying deals in a group-buying service. In one implementation, the functionality operates by receiving deal information from deal-providing entities (such as merchants). The deal information describes plural group-buying deals. The functionality then assigns a number of impressions to each deal, to provide allocation information. That is, the number of impressions for each deal describes a number of times that the deal will be presented to users. The functionality performs the assigning operation in such a manner so as to maximize revenue provided to an entity which administers the group-buying service.

According to another illustrative feature, the functionality then presents deals to users in accordance with the allocation information. For example, if the allocated number of impressions for a certain deal is x, then the functionality will provide x opportunities for users to select this deal.

The functionality may confer certain benefits to different entities associated with the group-buying service. For example, the functionality facilitates and expedites the setting up and subsequent modification of deals. The functionality also provides a mechanism for increasing the profitability of the entity which administers the group-buying service.

The above approach can be manifested in various types of systems, components, methods, computer readable storage media, data structures, articles of manufacture, and so on.

This Summary is provided to introduce a selection of concepts in a simplified form; these concepts are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 shows an illustrative group-buying system that implements a group-buying service.

FIG. 2 shows an illustrative user interface presentation for presenting one or more deals to a user, where those deals are selected by the group-buying system of FIG. 1.

FIG. 3 shows one illustrative implementation of the group-buying system of FIG. 1.

FIG. 4 is a procedure that sets forth an overview of one manner of operation of the group-buying system of FIG. 1. Part of the procedure involves assigning impressions to deals.

FIG. 5 is a procedure that sets forth one manner of assigning impressions to deals in the context of the procedure of FIG. 4.

FIG. 6 describes a data structure that may be used by the group-buying system to perform the procedure of FIG. 5.

FIG. 7 shows illustrative computing functionality that can be used to implement any aspect of the features shown in the foregoing drawings.

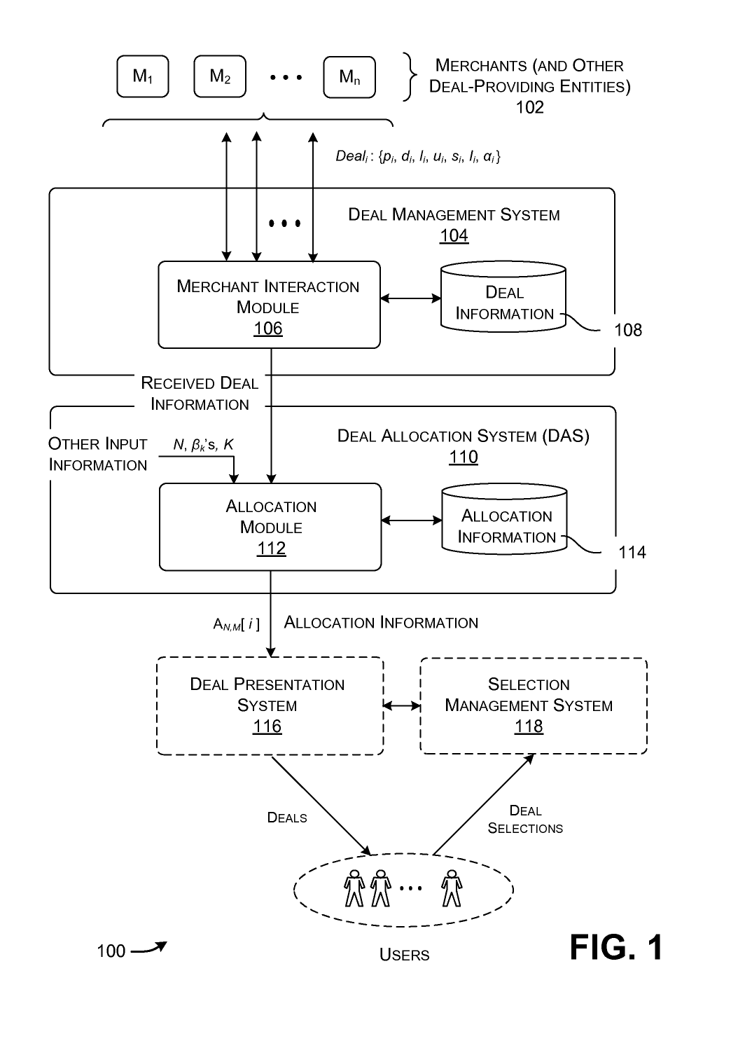

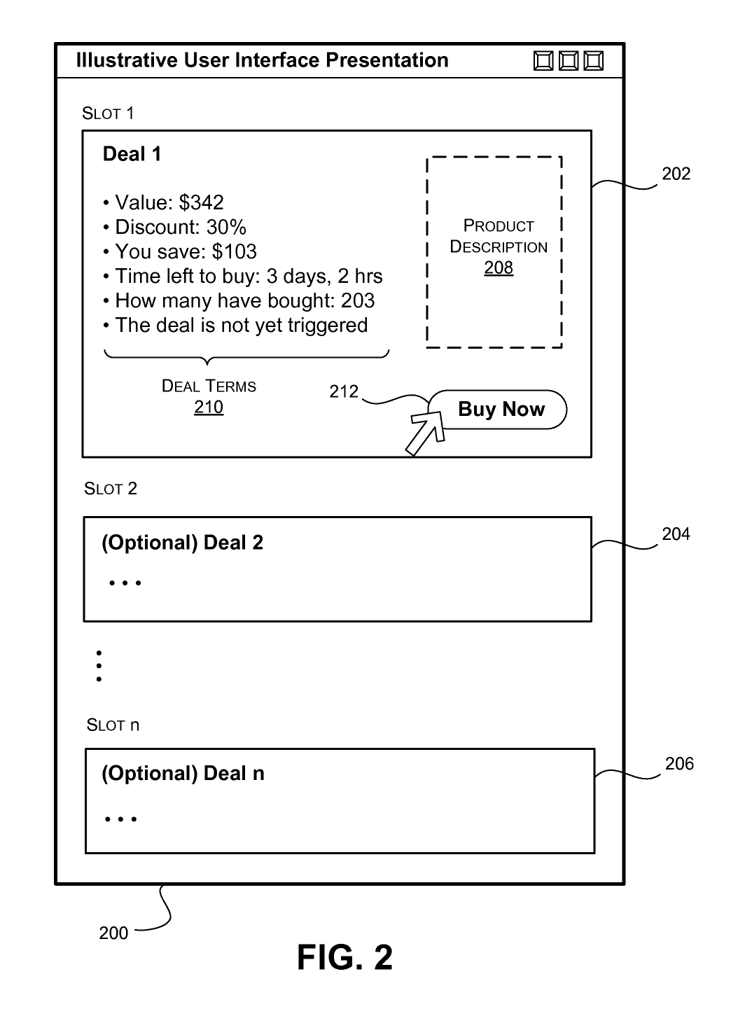

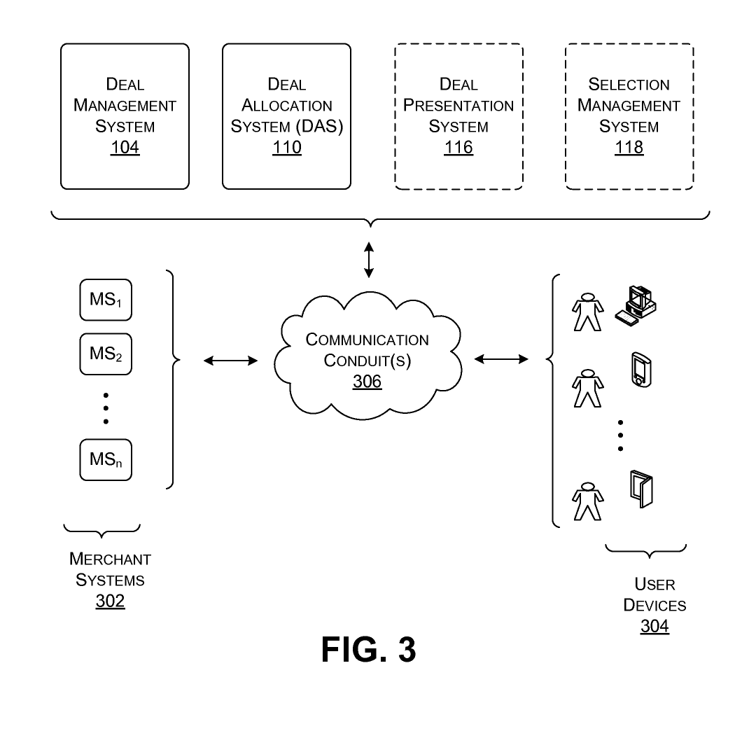

The same numbers are used throughout the disclosure and figures to reference like components and features. Series 100 numbers refer to features originally found in FIG. 1, series 200 numbers refer to features originally found in FIG. 2, series 300 numbers refer to features originally found in FIG. 3, and so on.

### DETAILED DESCRIPTION

This disclosure is organized as follows. Section A describes illustrative functionality for implementing a group-buying service. Section B describes illustrative methods which explain the operation of the functionality of Section A. Section C describes illustrative computing functionality that can be used to implement any aspect of the features described in Sections A and B.

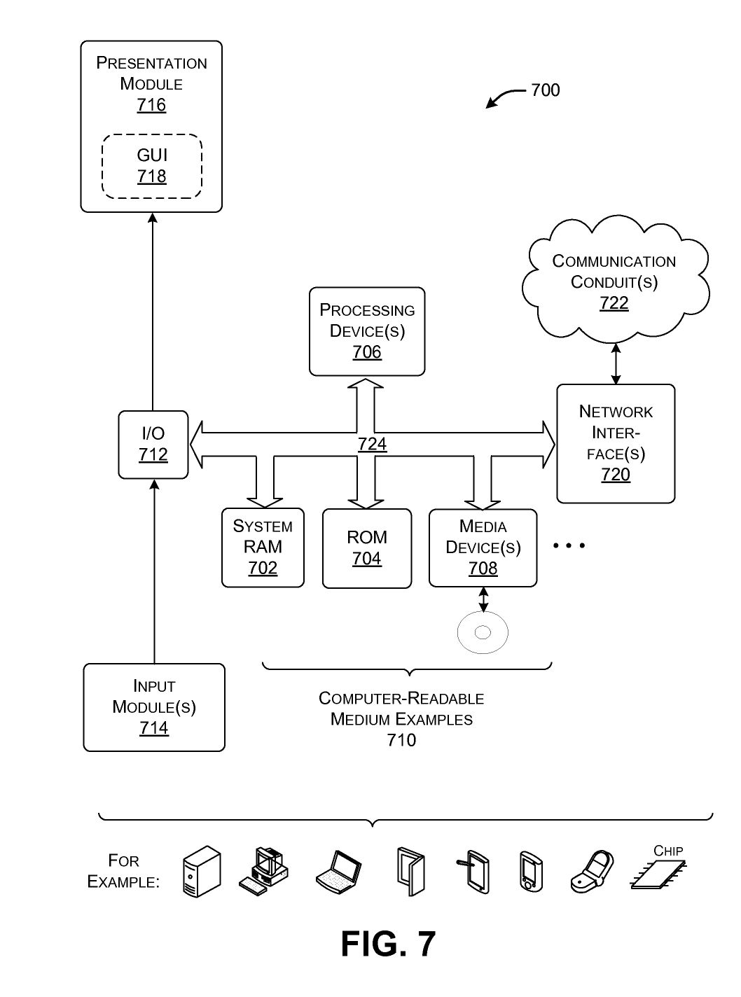

As a preliminary matter, some of the figures describe concepts in the context of one or more structural components, variously referred to as functionality, modules, features, elements, etc. The various components shown in the figures can be implemented in any manner by any physical and tangible mechanisms, for instance, by software, hardware (e.g., chip-implemented logic functionality), firmware, etc., and/or any combination thereof. In one case, the illustrated separation of various components in the figures into distinct units may reflect the use of corresponding distinct physical and tangible components in an actual implementation. Alternatively, or in addition, any single component illustrated in the figures may be implemented by plural actual physical components. Alternatively, or in addition, the depiction of any two or more separate components in the figures may reflect different functions performed by a single actual physical component. FIG. 7, to be discussed in turn, provides additional details regarding one illustrative physical implementation of the functions shown in the figures.

Other figures describe the concepts in flowchart form. In this form, certain operations are described as constituting distinct blocks performed in a certain order. Such implementations are illustrative and non-limiting. Certain blocks described herein can be grouped together and performed in a single operation, certain blocks can be broken apart into plural component blocks, and certain blocks can be performed in an order that differs from that which is illustrated herein (including a parallel manner of performing the blocks). The blocks shown in the flowcharts can be implemented in any manner by any physical and tangible mechanisms, for instance, by software, hardware (e.g., chip-implemented logic functionality), firmware, etc., and/or any combination thereof.

As to terminology, the phrase “configured to” encompasses any way that any kind of physical and tangible functionality can be constructed to perform an identified operation. The functionality can be configured to perform an operation using, for instance, software, hardware (e.g., chip-implemented logic functionality), firmware, etc., and/or any combination thereof.

The term “logic” encompasses any physical and tangible functionality for performing a task. For instance, each operation illustrated in the flowcharts corresponds to a logic component for performing that operation. An operation can be performed using, for instance, software, hardware (e.g., chip-implemented logic functionality), firmware, etc., and/or any combination thereof. When implemented by a computing system, a logic component represents an electrical component that is a physical part of the computing system, however implemented.

The phrase “means for” in the claims, if used, is intended to invoke the provisions of 35 U.S.C. §112, sixth paragraph. No other language, other than this specific phrase, is intended to invoke the provisions of that portion of the statute.

The following explanation may identify one or more features as “optional.” This type of statement is not to be interpreted as an exhaustive indication of features that may be considered optional; that is, other features can be considered as optional, although not expressly identified in the text. Finally, the terms “exemplary” or “illustrative” refer to one implementation among potentially many implementations

A. Illustrative Group-Buying System

FIG. 1 shows an illustrative group-buying system 100 that implements a group-buying service. In such a service, the group-buying system 100 provides grouping-buying deals (henceforth, just “deals”) that offer contingent benefits to users. In some cases, for instance, such a deal may offer a discount on an original price of an item, providing that a prescribed number of users have purchased the item in a prescribed timeframe. As used herein, an item may correspond to any type of product, service, etc., or any combination thereof. In other cases, an item may correspond to a right to purchase any item provided by a store or other establishment at a discounted price.

However, the principles described herein are not limited to particular kinds of group-buying deals. That is, the deals can be structured in any manner based on any environment-specific considerations. For instance, a group-buying deal can be formulated based on any type of triggering event or events pertaining to the purchase activity behavior of a group of users. Further, a group-buying deal can specify any type of reward or benefit to be provided to a user. Further, the group-buying system 100 can convey the reward in any form, such as a tangible redeemable certificate, an electronic discount that is redeemable in online fashion, and so on.

The group-buying system 100 includes plural entities that perform different respective functions. Starting at the top of the FIG. 1, the group-buying system 100 includes any number of deal-providing entities 102. Each deal-providing entity sponsors one or more deals pertaining to any type of items. For example, some deal-providing entities 102 may correspond to merchants which offer deals on merchandise and/services which they sell.

A deal management system 104 receives deal information from the deal-providing entities 102. The deal information describes the deals. More specifically, in one implementation, the deal information is expressed in a standard format to promote automated processing and interpretation of the deal. Without limitation, in one implementation, the deal information may include the following descriptive features regarding an individual deal i.

(a) Deal Description (xᵢ). The description describes the item to which the deal applies in any format and in any level of detail.

(b) Original Price (pᵢ). The original price describes the price of the item without application of the discount associated with the deal.

(c) Discount (dᵢ). The discount describes the discount or other benefit conferred by the deal. For example, the discount can be specified in terms of a percentage of the original price.

(d) Minimum Number of Purchases (lᵢ). The minimum number of purchases describes the number of purchases that users are required to make in order for the discount of the deal to be invoked.

(e) Maximum Number of Purchases (uᵢ). The maximum number of purchases (if applicable) describes a number of purchases beyond which the deal no longer applies. In other implementations, each of the thresholds lᵢ and uᵢ can be expressed by other purchase-related events, such as a collective amount of money expended by users on the item associated with the deal in question.

(f) Shared Revenue (sᵢ). The shared revenue pertains to an amount of revenue associated with the deal that the deal-providing entity agrees to give to an entity which administers the group-buying service. A deal-providing entity can specify the shared revenue as a percent of the original price or the discounted price.

(g) Time Span (tᵢ). The time span describes a period of time for which the deal remains active. For example, the time span can be specified in terms of a starting time and an ending time. Users are expected to meet the terms of the deal within that prescribed time period in order to earn the deal's discount.

The above-described descriptive features are set forth by way of example, not limitation. In other implementations, a deal-providing entity can provide additional information regarding a deal. In addition, or alternatively, a deal-providing entity can omit one or more of the descriptive features cited above.

The deal management system 104 can include a merchant interaction module 106 for receiving the above-described deal information from the deal-providing entities 102. The merchant interaction module 106 can receive the deal information in different ways. In one approach, the merchant interaction module 106 can host an application page which asks a deal-providing entity to fill out an online form having fields corresponding to the above-described descriptive features. In another case, the merchant interaction module 106 can allow any deal-providing entity to submit a document that expresses the above-described descriptive features in a standard format. The merchant interaction module 106 then parses the document to extract the descriptive features of the deal. In any event, the merchant interaction module 106 can store the deal information that it receives in a data store 108.

The merchant interaction module 106 also allows users to modify deals at any given time. For example, a deal-providing entity may forward original deal information at the outset of a sales campaign. Thereafter, the deal-providing entity may modify any aspect of the originally-presented deal information prior to activation of the deal. The deal-providing entity can also modify any aspect of the deal information after the deal has terminated (e.g., in preparation for its later reactivation). In general, the deal-providing entity may decide to modify its original deal for any environment-specific reason. In one case, the deal-providing entity may observe that the terms of the original deal have resulted in the failure of the deal to be published by the group-buying service. In another case, the deal-providing entity may wish to modify the deal so as to increase or decrease acceptance of the deal once it is presented.

In any event, according to one implementation, the deal-providing entities 102 can formulate and forward the deal information without assistance from any personnel associated with the group-buying service. This aspect may facilitate the submission and processing of deals from the standpoint of both the deal-providing entities 102 and the entity which administers the group-buying service. For example, the group-buying service need not devote human resources to assisting the deal-providing entities 102 in submitting their deals. This aspect, in turn, allows the group-buying service to easily “scale up” when it needs to process an increased flow of deals submitted by deal-providing entities 102, e.g., upon expanding the group-buying service to a new marketplace, or upon encountering increased demand during a holiday season, etc.

A deal allocation system (DAS) 110 can extract deal information from the deal management system 104 for processing on any basis. For example, the DAS 110 can extract the deal information from the deal management system 104 at the start of each day (or other periodic basis). Alternatively, or in addition, the DAS 110 can extract deal information from the deal management system 104 on an on-demand basis (e.g., based on the receipt of a prescribed number of new deals at the deal management system 104). The DAS 110 can use a push technique and/or a pull technique and/or some other technique to extract the deal information.

Upon loading the deal information, an allocation module 112 then operates on the deal information by assigning a number of impressions to each of the deals identified in the deal information. An impression corresponds to a single opportunity for a user to consider a deal. For example, consider a deal which is assigned 500 impressions. This means that the group-buying system 100 presents the deal to 500 users. In some cases, the 500 users may correspond to 500 distinct individuals; but, more generally, the 500 users may correspond to 500 distinct encounters with the group-buying service by any combination of individuals (that is, not necessarily 500 distinct people).

Next consider a deal which is assigned zero impressions. This means that the group-buying system 100 does not present the deal to any users. As this latter example demonstrates, the allocation module 112 also implicitly performs the function of selecting a subset of deals from a total number M of deals specified by the deal-providing entities 102. And for this reason, the deals submitted by the deal-providing entities 102 can be referred to as candidate deals (since the allocation module 112 treats them as candidates for presentation).

The allocation module 112 performs the above-described assignment operation based on the deal information specified above. In addition, FIG. 1 indicates that the allocation module 112 may receive additional information from one or more sources. For example, the allocation module 112 may receive a conversion probability (aᵢ) for each deal under consideration. The conversion probability identifies a probability that users will select the deal upon being presented with the deal. In one case, the deal-providing entity which submits the deal in question may provide the conversion probability, along with the other descriptive features identified above. For instance, the deal-providing entity may generate this value by collecting information regarding how many times the deal has been presented to users in the past, together with information regarding how many times the deal has been selected by the users. Alternatively, or in addition, the DAS 110 itself, and/or the deal management system 104, and/or some other monitoring entity can generate the conversion probability for a deal based on its own historical records regarding the prior deal-related behavior of users.

In addition, the allocation module 112 can receive an estimate of a total number (N) of impressions that the group-buying service receives in a specified timeframe (such as each day). N represents the total number of impressions that are available to be allocated to different deals received the deal-providing entities 102. In one implementation, the total number of impressions may correspond to a number of visitors that the website associated with the group-buying service typically receives in the course of a day. More generally, different implementations can specify this “total number” value in any level of granularity. For example, in some cases, the DAS 110 can formulate a single number N that represents a daily traffic value, formed by computing an average of the recorded daily traffic values over a prescribed span of time, without otherwise taking into account possible lulls and spikes in traffic over that timeframe. In other cases, the DAS 110 can provide plural N's that reflect typical traffic that is experienced during different time periods, such as at certain times of the day, certain days of the week, certain days of the year, and so on. The allocation module 112 can then select and apply whatever N value is appropriate depending on the time period (e.g., the day of the week) in which the allocation module 112 is currently operating.

Section B (below) will describe different algorithms that the allocation module 108 can use to assign impressions to the M deals that have been specified by the deal-providing entities 102. By way of overview, the allocation module 108 attempts to assign impressions to deals in such a manner that the revenue provided to the entity which administers the group-buying service is maximized.

The following example provides a high-level demonstration of the manner in which two different allocations of impressions affects the revenue conferred to the group-buying service. Assume that the group-buying service receives two million visitors per day. This means that N is two million. Further assume that the group-buying service shows one deal to each visitor. Further assume that there are only two candidate deals, D₁ and D₂. Hence, M, the total number of deals, is just 2 in this case. The first deal is expressed by the following deal information: D₁={p₁=$400, d₁=0.5, l₁=100, u₁=150, s₁=0.5, and α₁=0.0001}. The second deal is expressed by the following deal information: D₂={p₂=$360, d₂=0.5, l₂=80, u₂=150, s₂=0.5, and α₂=0.0001}.

Based on this deal information, the allocation module 112 concludes that it needs to allocate at least 1 million visitors to the first deal (D₁), and 1.5 million of visitors at most. These figures are produced by dividing l₁ and u₁, respectively, by α₁. Similarly, the allocation module 112 concludes that it needs to allocate at least 0.8 million visitors to the second deal (D₂), and 1.5 million at most.

Further, the expected per-visitor revenue (wᵢ) of any deal i is pᵢdᵢsᵢαᵢ. Hence, the expected per-visitor revenue for the first deal is w₁=p₁d₁s₁α₁=$0.01. The expected per-visitor revenue for the second deal is w₂=p₂d₂s₂α₂=$0.009.

Now consider a first allocation strategy that involves allocating 1.5 million visitors to deal D₁. This leaves only 0.5 million visitors (out of the total number of 2 million visitors) for deal D₂. Deal D₂, however, requires a minimum of 0.8 million visitors to be effective. This, in turn, means that the deal-providing entity can only derive revenue from the first deal. That amount of revenue is thus specified by R=w₁*1.5M=$1500.

Now consider a second allocation strategy which involves assigning 1.2 million visitors to deal D₁ and 0.8 million visitors to the deal D₂. With these allocations, both deal D₁ and deal D₂ are now effective revenue-producing deals. The total revenue for this case is specified by R=w₁*1.2M+w₂*0.8M=$1920. The second allocation strategy is therefore preferable over the first allocation strategy because it earns the group-buying service more revenue than the first allocation strategy.

The allocation module 112 can use various techniques to automatically make the type of assignment-related decisions described above. In one approach, the allocation module 112 can use a dynamic programming technique to perform this task, several versions of which are described in Section B. In this approach, after performing a series of preliminary calculations, the allocation module 112 formulates its final conclusion as a set of M final deal allocation values. The set of M deal allocation values describe the numbers of impressions assigned to the respective M candidate deals, based on a consideration of a total number N of impressions that are available for assignment. This output of the allocation module 112 is also more generally referred to as “allocation information” herein. The allocation module 112 stores the allocation information in a data store 114.

A deal presentation system 116 then presents deals to users based on the allocation information. For example, suppose that a particular deal D is assigned 300 impressions, out of 1 million available impressions (that is, N=1 million). This means that the deal presentation system 116 will present the deal D to 300 visitors to the group-buying service, out of 1 million visitors expected in a day.

The deal presentation system 116 can use different strategies to satisfy the allocation conditions specified by the allocation information. In one case, the deal presentation system 116 presents the viable deals to visitors in round-robin fashion. For example, the deal presentation system 116 can present a first deal D₁ to a first visitor, a second deal D₂ to a second visitor, a third deal D₃ to a third visitor, etc. Once the deal presentation system 116 reaches the assigned allocation quota of a particular deal (e.g., 300 in the example above), it will skip this deal in its subsequent distribution of deals. In an alternative approach, the deal presentation system 116 can present the same deal (or set of deals) to users until the allocations associated with those deals are met, before moving on to presenting other deals. For example, the deal presentation system 116 can present deal D₁ to users until the allocation quota for that deal is met, upon which it commences presenting deal D₂ to users, and so on. These scenarios are presented by way of example, not limitation; the deal presentation system 116 can apply yet other allocation/throttling strategies to parse out deals to different users who visit the group-buying service.

In any event, the deal presentation system 116 may result in the allocation of different sets of deals to different users. That is, in some scenarios, two users who access the group-buying service at about the same time may or may not be presented with the same deal or deals. Further, in some scenarios, a user who accesses the group-buying service at different times may or may not be presented with the same deal or deals.

A selection management system 118 can perform various tasks in response to the selections of a deal by a user. For example, the selection management system 118 can update a bookkeeping record associated with the selected deal to indicate that a user has selected the deal. The selection management system 118 can also provide various notifications to the user regarding the status of a deal, e.g., as conveyed via the deal presentation system 116 and/or through some other channel. In addition, the selection management system 118 can convey any information to the associated deal-providing entity which sponsors the deal. That information, for instance, may identify the number of times that the deal has been presented, the number of times that the deal has been selected, and so on. The selection management system 118 can also perform any purchase-related processing when a user purchases the deal. Alternatively, or in addition, the selection management system 118 can delegate any part of the purchase-related processing to other components of the group-buying system 100, including the deal-providing entities 102 themselves.

FIG. 2 shows an illustrative user interface presentation 200 that the deal presentation system 116 can use to present one or more deals to a user, based on the allocation information generated by the allocation module 112.

In one approach, the deal presentation system 116 presents a single deal to each user who visits the group-buying service at any given time. The user interface presentation 200 presents this deal in a single display slot, e.g., slot 202.

In another approach, the deal presentation system 116 presents two or more deals to a user who visits the group-buying service at any given time. That is, the user interface presentation 200 presents K such plural deals in corresponding K display slots, e.g., slots 202, 204, . . . 206. In one implementation of the multi-slot approach, the deal presentation system 116 assigns no more than one deal to a slot for any visitor (or, more generally, to any impression). Further, the deal presentation system 116 assigns a deal to no more than one slot for any visitor/impression. However, these rules can be relaxed to varying extents in other implementations of the group-buying system 100.

As will be described in Section B, the allocation module 112 can use different allocation algorithms for the single-slot case and the multi-slot case. For the multi-slot case, the allocation module 112 can also receive, as input, a slot probability (βₖ) associated with each slot k. The slot probability can be used to determine the fraction Nₖ of the total number of impressions (N) that a particular slot is expected to receive, that is, Nₖ=Nβₖ, and N=N₁+N₂+ . . . N_{K}. The slot probability values can be derived by noting the frequencies at which users select deals presented in different slots.

The deal presentation system 116 can provide any deal-related information to a user. For example, consider Deal 1 which is presented in slot 202 of FIG. 2. The deal presentation system 116 can provide a product description 208 which describes the type of item to which the deal applies. The product description 208 can convey this information using textual information, pictorial information, video information, audio information, etc., or any combination thereof. The deal presentation system 116 can also provide deal term information 210 which describes the terms of the deal. The deal presentation system 116 can also provide a command button 212 or the like which allows a user to purchase the deal in question.

In the example of FIG. 2, the user may proactively access the user interface presentation 200 by accessing a website or the like associated with the web-buying service. In addition, or alternatively, the deal presentation system 116 can insert deals into other pages sponsored by other services. In these examples, the user may not proactively be seeking to explore existing group-buying deals. Nevertheless, to facilitate description, any user who actively or passively encounters a group-buying deal is referred to as a “visitor” of the group-buying service.

FIG. 3 shows one illustrative implementation of the group-buying system 100 of FIG. 1. In one case, the group-buying system 100 can implement the deal management system 104, the deal allocation system (DAS) 110, the deal presentation system 116, and the selection management system 118 as four respective components. For example, the group-buying system 100 can implement each component by one or more server computers in conjunction with one or more data stores. In one case, the group-buying system 100 can implement all four of these components at a single site. In another case, the group-buying system 100 can implement two or more of these components in distributed fashion at two or more separate sites.

Similarly, in one case, a single entity can administers all four of these components (the deal management system 104, the DAS 110, the deal presentation system 116, and the selection management system 118). In another case, two or more different entities can administer these four components. To simplify explanation, it will henceforth be assumed that the group-buying service is associated with a network-accessible website that is implemented by a single entity. That entity uses the DAS 110 to allocate impressions to deals in the above-described manner with the objective of maximizing the revenue that is receives from participating deal-providing entities.

The deal-providing entities 102 (illustrated in FIG. 1) can use respective merchant systems (MS) 302 to interact with the group-buying service. For example, in one case, a merchant system can correspond to one or more computers and one or more associated data stores. As one task, the merchant systems 302 send deal information to the deal management system 104. Each instance of that deal information identifies a deal that a deal-providing entity wishes to post via the group-buying service.

The end users can use respective user devices 304 to interact with the group-buying service, e.g., through the deal presentation system 116 and the selection management system 118. A user device can correspond to any type of computing functionality, such as a personal computer, a computer work station, a laptop computing device, a netbook computing device, a game console device, a set-top box device, a tablet computing device, a smartphone or other type of mobile phone, a personal digital assistant device, a portable game device, an electronic book reader device, and so on.

A communication conduit 306 of any type can couple together the components described above. In one case, the communication conduit 306 corresponds to a wide area network (e.g., the Internet), a local area network, or a combination thereof. The communication conduit 306 can include any combination of hardwired links, wireless links, etc.

B. Illustrative Processes

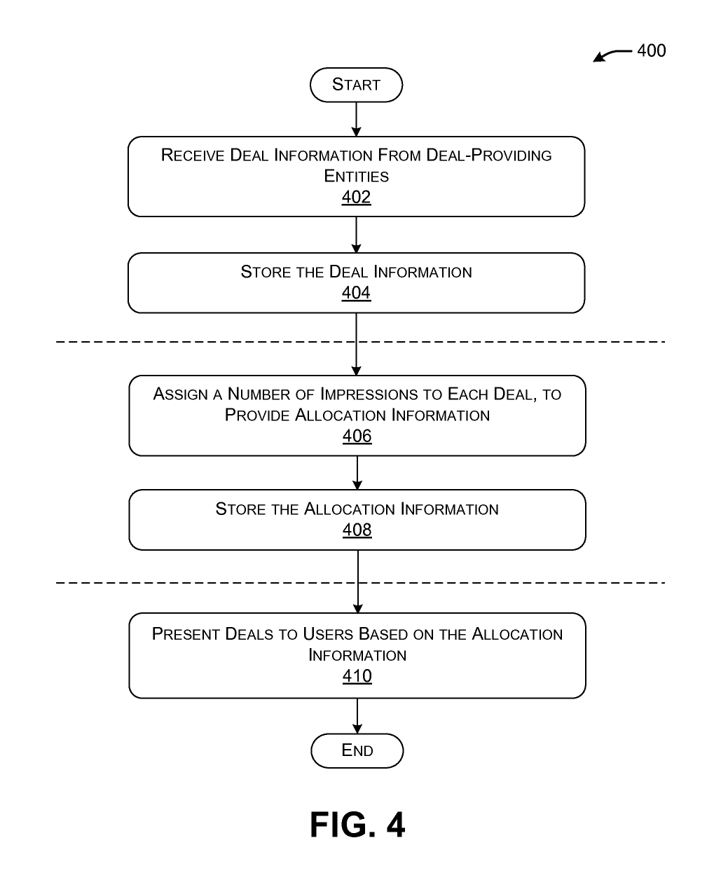

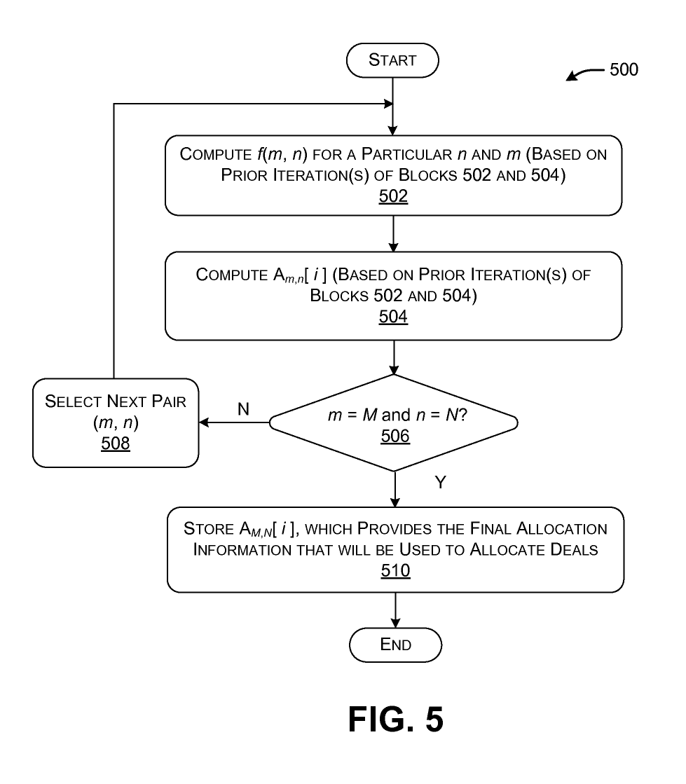

FIGS. 4 and 5 show procedures that explain one manner of operation of the group-buying system 100 of FIG. 1. Beginning with FIG. 4, this figure shows a procedure 400 that sets forth for an overview of one manner of operation of the group-buying system 100 of FIG. 1. In block 402, the deal management system 104 receives deal information from plural deal-providing entities 102. That deal information describes M candidate deals using, for example, the descriptive features set forth in Section A. In block 404, the deal management system 104 stores the deal information. In block 406, the DAS 110 extracts the deal information and assigns a number of impressions to each of the M candidate deals, to provide allocation information. Any candidate deal that receives a number of impressions equal to zero will not be presented. In block 408, the DAS 110 stores the allocation information. The DAS 110 can perform blocks 406 and 408 on any basis, such as a periodic basis (e.g., a daily basis), an on-demand basis, etc. In block 410, the deal presentation system 116 presents deals to users based on the allocation information.

FIG. 5 is a procedure 500 that sets forth one manner by which the allocation module 112 can assign impressions to deals using a dynamic programming technique. In other words, the procedure 500 represents one way of implementing block 406 of FIG. 4.

In block 502, the allocation module 112 uses a function ƒ(m, n) to determine maximum revenue that can be gained by the group-buying service for a provisional case in which there are m candidate deals and n total impressions. More specifically, assume that the absolute total number M of candidate deals is arranged in any arbitrary order, such as the order in which the M candidate deals were received from the deal-providing entities 102. The allocation module 112 identifies the first m candidate deals within the total number of M candidate deals, and generates the maximum revenue based on a consideration of this set of m candidate deals, together with n impressions, where n≦N.

In block 504, the allocation module 1210 computes an m-dimensional vector A_{m,n}[i] that allocates a set of deal allocation values to the m respective candidate deals under consideration, with respect to the n total impressions. That is A_{m,n}[i] has elements that identify the numbers of impressions assigned to the M deals. For instance, A_{m,n}[5] identifies the number of impressions allocated to the fifth deal.

In block 506, the allocation module 112 determines whether the m and n numbers just considered correspond to the absolute total number (M) of deals and the absolute total number (N) of impressions, respectively. If not, the allocation module 112 selects a next pair (m, n) to consider. For example, the allocation module 112 can increment the number of impressions by 1, that is n=n+1. Or if n=N, then the allocation module 112 can increment the number of deals by 1, that is m=m+1. The allocation module 112 then repeats blocks 502 and 504 for the updated pair of (m, n). As will be clarified below, each iteration of blocks 502 and 504 (except for the very first pass), generates ƒ(m, n) and A_{m,n}[i] based on the results of previous iterations of blocks 502 and 504.

If block 506 is answered in the affirmative, then, in block 510, the allocation module 112 stores the final allocation information. The final allocation information comprises an M-element vector A_{M,N}[i] that indicates final deal allocation values for the respective M candidate deals, considered with respect to a total number N of available impressions. Some of the allocation values in this final vector may be zero, indicating that the corresponding deals are each assigned zero impressions. Hence, the allocation operation also has the effect of selecting a subset of viable deals out of a total number M of candidate deals, since the deal presentation system 116 will not present any deal that has been assigned zero impressions.

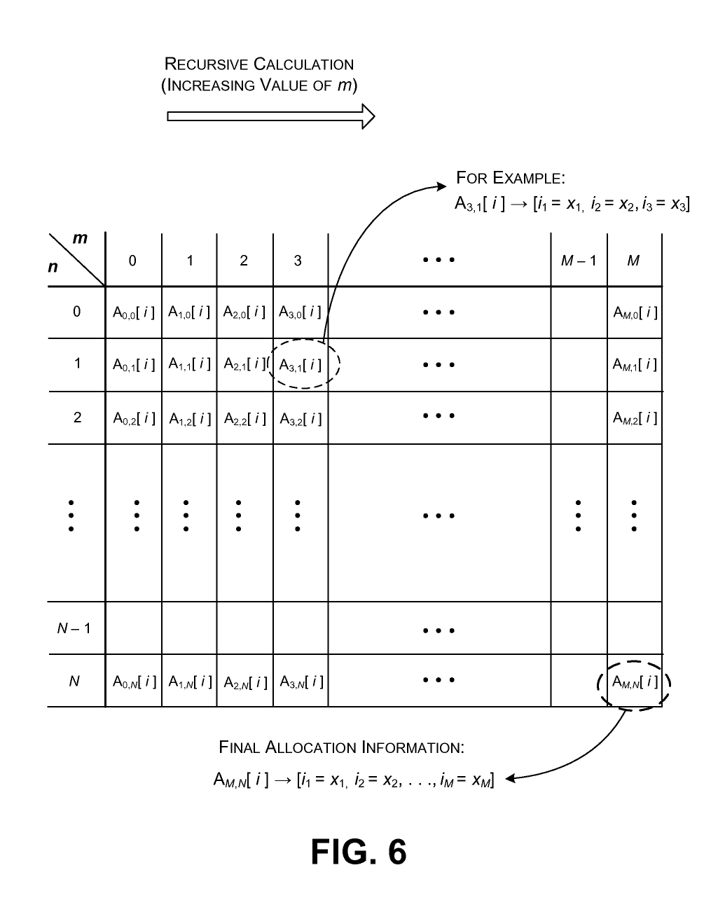

FIG. 6 shows a data structure that stores the vectors A_{m,n}[i] that are computed by the recursive procedure 500 of FIG. 5. The allocation module 112 starts with an initial seed case of m=0, n=0, corresponding to the entry that appears in the upper left-hand corner of the data structure of FIG. 6. The allocation module 112 then successively fills out the first column in the data structure, before advancing to the second column, and so on. In the final calculation, the allocation module 112 generates the final allocation information, corresponding to the vector A_{M,N}[i] that appears in the lower right-hand corner of the data structure.

The DAS 110 can apply different versions of the basic approach described above to address different ways in which the group-buying problem is defined. The following explanation describes four representative versions of the algorithm described in FIG. 5.

B.1. Scenario 1: Single Slot

In the first case, the deal presentation system 116 presents a single deal to a user at any given time (e.g., K=1 for this case). To begin with, the DAS 110 can conclude that ƒ(m, n)=0 for all cases in which m=0, and in all cases in which n=O. That is, ƒ(m, 0)=0 for m=0, 1, . . . M, and ƒ(0, n)=0 for n=0, 1, . . . , N. Further, the DAS 110 can conclude that A_{m,0}[i]=0 for 1≦i≦m≦M. The DAS 110 can use these initial assumptions as seed values for input into the iterative algorithm described in FIG. 5.

For any other pair (m, n), the DAS 110 can calculate ƒ(m, n) and A_{m,n}[i] in the following manner. First, the value \hat{x} is denoted as:

\hat{x}=arg maxₓ₌ₗ_{ₘ}^{min{n,u}^{ₘ}^{}}(ƒ(m−1,n−x)+wₘx).

In this equation, the component wₘx refers to the revenue that will be produced upon assigning x impressions to the m-th deal. Recall from Section A that the revenue of any deal i can be computed based on wᵢ=pᵢdᵢsᵢαᵢ. The component ƒ(m−1, n−x) refers to the maximum revenue that can be produced by assigning the remaining impressions (n−x) to the remaining deals (m−1). More specifically, the DAS 110 can extract the revenue value associated with ƒ(m−1, n−1) from a stored revenue value provided in a previous iteration of block 502 (of FIG. 5). Taken all together, the above expression identifies the particular value of x for which (ƒ(m−1, n−x)+wₘx) is the greatest. That value of x is denoted as x.

Given this value of \hat{x}, the DAS 110 can calculate the value of ƒ(m, n) and A_{m,n}[i] in the following manner. Consider a first case in which ƒ(m−1, n)≧(ƒ(m−1, n−\hat{x})+wₘ\hat{x}). The DAS 110 can set the value of ƒ(m, n) to ƒ(m−1, n). The value for ƒ(m−1, n) can be obtained based on a previous iteration of block 502. Further, the DAS 110 sets A_{m,n}[i]=A_{m,1n}[i] for all deals i, 1≦i≦m−1 (where A_{m-1,n}[i] can be obtained from a previous iteration of block 504). For the last-added deal m, A_{m,n}[m]=0.

Next consider the case in which ƒ(m−1, n)<(ƒ(m−1, n−\hat{x})+wₘ\hat{x}). The DAS 110 can set the value of ƒ(m, n) to ƒ(m−1, n−\hat{x})+wₘ\hat{x}. Further, the DAS 110 can set A_{m,n}[i]=A_{m-1,n-\hat{x}}[i] for all deals i, 1≦i≦m−1. For the last-added deal m, A_{m,n}[m]=\hat{x}.

Based on the above logic, the value of ƒ(m, n) can be expressed in a more succinct fashion as:

ƒ(m,n)=max{ƒ(m−1,n),maxₓ₌ₗ_{ₘ}^{min{n,u}^{ₘ}^{}}(ƒ(m−1,n−x)+wₘx)}.

As indicated above when describing FIG. 5, the DAS 110 can iteratively calculate values for ƒ(m, n) and A_{m,n}[i] in the above-indicated manner until it finally generates A_{M,N}[i]. The deal allocation values in A_{M,N}[i] provide the numbers of impressions to be assigned to the respective M candidate deals.

The running time for the first scenario is O(N²M). This is because the calculation of each ƒ(m, n) involves n≦N items, and that are MN values of ƒ(m, n) to calculate.

B.2. Scenario 2: Multiple Slots, with lᵢ=uᵢ

Next consider the case in which the deal presentation system 116 presents two or more deals to each user at any given time. But this multi-slot case is otherwise simplified by assuming that, for each deal, the minimum number of purchases (lᵢ) equals the maximum number of purchases (uᵢ). Further, in this case, the DAS 110 orders the deals in descending order of lᵢ. That is, l₁≧l₂≧ . . . ≧l_{M}.

For this case, the maximum revenue that can be obtained for the pair (m, n) is given by:

$$f ( m , n ) = max \{ f ( m - 1 ) , f ( m - 1 n - {l}_{m} ) + {w}_{m} {l}_{m} ) I ( {A}_{m - 1 , n - {l}_{m}} ⋃ {l}_{m} \}$$

$$where \text{:}$$

$$I \{ {A}_{m - 1 , n - {l}_{m}} ⋃ {l}_{m} \} = \{ \begin{matrix}1 & if {A}_{m - 1 , n - {l}_{m}} ⋃ {l}_{m} is feasible \\ 0 & otherwise .\end{matrix}$$

To calculate whether allocating lₙ impressions to the m-th deal based on the strategy A_{m-1,n-l}_{ₘ} is feasible, the DAS 110 can rely on the following validation algorithm.

### Illustrative Validation Procedure

Step 1: Input the allocation strategy A_{m,n} and Nₖ, for k=1, 2, . . . K. As explained in Section A, the value Nₖ describes a fraction of a total number N of impressions allocated to slot k, where there are K slots in total.
Step 2: For each k from 1 to K, perform Steps 3 and 4.
Step 3: If Σⱼ₌₁^{m}A_{m,n}[j]>Σⱼ₌₁^{k}Nⱼ, check whether the inequality ST(A_{m,n,k})≦Σⱼ₌₁^{k}Nⱼ holds. ST(A_{m,n,k}) refers to the sum of the largest k non-zero elements in the strategy A_{m,n}. If this relationship does not hold, then conclude that the strategy is not feasible and terminate the validation procedure.
Step 4: If Σⱼ₌₁^{m}A_{m,n}[j]≦Σⱼ₌₁^{k}Nⱼ, then conclude that the strategy is feasible and terminate the validation procedure.

The DAS 110 also updates A_{m,n} upon each iteration of the algorithm shown in FIG. 5. The DAS 110 performs this task by invoking one of the following three assignment rules at each iteration.

(a) If A_{m-1,n-l}_{ₘ}∪lₘ is not feasible or ƒ(m−1, n)>ƒ(m−1, n−lₘ)+wₘlₘ, the DAS 110 will set A_{m,n}[i]=A_{m-1,n}[i], for i=1, 2, . . . , m−1, and A_{m,n}[m]=0.

(b) If A_{m-1,n-l}_{ₘ}∪lₘ is feasible and ƒ(m−1, n) G ƒ(m−1, n−lₘ)+wₘlₘ, the DAS 110 will set A_{m,n} [i]=A_{m-1,n-l}_{ₘ}[i], for i=1, 2, . . . , m−1, and A_{m,n}[m]=lₘ.

(c) If A_{m-1,n-l}_{ₘ}∪lₘ is feasible and ƒ(m−1, n)=ƒ(m−1, n−lₘ)+wₘlₘ, the DAS 110 will set A_{m,n}[i]=A_{m-1,n-l}_{ₘ}[i], for i=1, 2, . . . , m−1, and A_{m,n} [m]=lₘ.

As before, the DAS 110 can iteratively calculate values for ƒ(m, n) and A_{m,n}[i] in the above-indicated manner until it finally generates A_{M,N}[i]. The deal allocation values in A_{M,N}[i] provide the numbers of impressions to be assigned to the M candidate deals.

The running time for the above-described calculation is, at worst, O(NM(K+M log M)). This is because the calculation of each ƒ(m, n) entails a feasibility check on the allocation strategy, and there are MN values of ƒ(m, n) to calculate. The feasibility check itself involves at most K comparisons to check the inequalities, and m log m comparisons to sort the elements in A_{m,n} (in order to get the k largest non-zero elements in A_{m,n}).

B.3. Scenario 3: Multiple Slots, with lᵢ<uᵢ, but with β₁=β₂= . . . βₖ

In the next case, the deal presentation system 116 again presents two or more deals to each user at any given time. This scenario, however, is more general than the second scenario because lᵢ<uᵢ for each deal, meaning that lᵢ and uᵢ are no longer equal. But this scenario introduces the simplification that all slots receive the same number of impressions, as indicated by the condition β₁=β₂= . . . βₖ.

The DAS 110 can address this scenario using a three-step approach. In a first step, the DAS 110 determines whether lᵢ>Nβ₁ for a particular deal. If so, the DAS 110 removes this deal, since no feasible allocation can select the deal. Similarly, the DAS 110 sets uᵢ=min{uᵢ,Nβ₁}.

In the second step, the DAS 110 converts the original multi-slot allocation problem into a one-slot allocation problem. That single slot contains Nβ₁ impressions. Further, the DAS 110 defines a minimum purchase value lᵢ′ for a deal i as lᵢ/K, and similarly, a maximum purchase value uᵢ′ for a deal i as uᵢ/K. The remaining descriptive features of the deals remain the same as they were originally specified.

In the third step, the DAS uses the single-slot dynamic programming method described in Section B.1 to find an optimal solution to the one-slot problem established in the second step. More specifically, the single-slot algorithm will assign a number xᵢ′ of impressions to each deal. The DAS 110 then defines the assignment for this deal in the context of the original multi-slot problem as xᵢ=Kxᵢ′. That is, since all slots receive an equal number of impressions, the DAS 110 multiples the per-slot value xᵢ′ by the total number of slots K.

B.4. Scenario 4: Multiple Slots, with lᵢ<uᵢ, and with β₁≧β₂≧ . . . ≧βₖ

In the next case, the deal presentation system 116 again presents two or more deals to each user at any given time. But this scenario is more general that the third scenario because the slots no longer need to receive equal numbers of impressions, e.g., as indicated by the condition β₁≧β₂≧ . . . ≧βₖ.

The DAS 110 can address this scenario using a three-step approach. In a first step, the DAS 110 converts each deal Dᵢ (with a minimum purchase value of lᵢ and a maximum purchase value of uᵢ) into component deal parts. Namely, the DAS 110 expresses Dᵢ as {(2⁰lᵢ,2⁰lᵢ), (2¹lᵢ,2¹lᵢ), . . . (2ⁱ^{ₖ}lᵢ,2ⁱ^{ₖ}lᵢ)}, where iₖ=└log₂(uᵢ/lᵢ)┘. This creates a new allocation problem for a newly generated set of deals, e.g., D′={D₁∪D₂∪ . . . ∪D_{M}}. Note that each deal part includes a pair, such as (2⁰lᵢ,2⁰lᵢ) for the first deal part. The first member of the pair is the lower bound of the deal part, and the second member of the pair is the upper bound of the deal part. In other words, this solution creates multiple pseudo-deals from each original deal, and all these pseudo-deals have fixed size, in which the lower bound equals the upper bound.

In the second step, the DAS 110 generates assignments for the deals defined in the first step using the allocation method described in Section B.2 above (e.g., where lᵢ=uᵢ).

In the third step, if the allocation operation in step two selects multiple deals from the same deal Dᵢ, then the DAS 110 can retain the largest one. This prevents the group-buying system 100 from presenting the same deal in two (or more) slots presented on a single page.

C. Representative Computing Functionality

FIG. 7 sets forth illustrative computing functionality 700 that can be used to implement any aspect of the functions described above. For example, the type of computing functionality 700 shown in FIG. 7 can be used to implement any aspect of the DAS 110, any aspect of the deal presentation system 116, any aspect of the selection management system 118, any aspect of a merchant system, any aspect of user device, and so on. In all cases, the computing functionality 700 represents one or more physical and tangible processing mechanisms.

The computing functionality 700 can include volatile and non-volatile memory, such as RAM 702 and ROM 704, as well as one or more processing devices 706 (e.g., one or more CPUs, and/or one or more GPUs, etc.). The computing functionality 700 also optionally includes various media devices 708, such as a hard disk module, an optical disk module, and so forth. The computing functionality 700 can perform various operations identified above when the processing device(s) 706 executes instructions that are maintained by memory (e.g., RAM 702, ROM 704, or elsewhere).

More generally, instructions and other information can be stored on any computer readable medium 710, including, but not limited to, static memory storage devices, magnetic storage devices, optical storage devices, and so on. The term computer readable medium also encompasses plural storage devices. In all cases, the computer readable medium 710 represents some form of physical and tangible entity.

The computing functionality 700 also includes an input/output module 712 for receiving various inputs (via input modules 714), and for providing various outputs (via output modules). One particular output mechanism may include a presentation module 716 and an associated graphical user interface (GUI) 718. The computing functionality 700 can also include one or more network interfaces 720 for exchanging data with other devices via one or more communication conduits 722. One or more communication buses 724 communicatively couple the above-described components together.

The communication conduit(s) 722 can be implemented in any manner, e.g., by a local area network, a wide area network (e.g., the Internet), etc., or any combination thereof. The communication conduit(s) 722 can include any combination of hardwired links, wireless links, routers, gateway functionality, name servers, etc., governed by any protocol or combination of protocols.

Alternatively, or in addition, any of the functions described in Sections A and B can be performed, at least in part, by one or more hardware logic components. For example, without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc.

In closing, functionality described herein can employ various mechanisms to ensure the privacy of user data maintained by the functionality. For example, the functionality can allow a user to expressly opt in to (and then expressly opt out of) the provisions of the functionality. The functionality can also provide suitable security mechanisms to ensure the privacy of the user data (such as data-sanitizing mechanisms, encryption mechanisms, password-protection mechanisms, etc.).

Further, the description may have described various concepts in the context of illustrative challenges or problems. This manner of explanation does not constitute an admission that others have appreciated and/or articulated the challenges or problems in the manner specified herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method, performed by computing functionality, for allocating deals in a group-buying service, comprising:
receiving deal information from plural deal-providing entities via a network, the deal information describing plural deals, each deal being invoked when purchase activity associated with the deal reaches a prescribed threshold;
storing the deal information in a data store;
assigning a number of impressions to each deal, to provide allocation information, the number of impressions for each deal describing a number of times that the deal will be presented to users; and
storing the allocation information in data structure in a data store,
where the receiving, storing the deal information, assigning, and storing the allocation information are implemented by the computing functionality.

2. The method of claim 1, further comprising presenting at least one deal to users based on the allocation information.

3. The method of claim 1, wherein the deal information associated with each deal includes:
an original price associated with an item to which the deal applies;
a discount associated with the deal;
a minimum number of purchases to be made in order for the discount of the deal to apply;
a maximum number of purchases beyond which the deal no longer applies;
a revenue to be provided to an entity which manages the deal; and
a time span for which the deal remains active.

4. The method of claim 1, further comprising receiving a conversion probability that describes a probability that users will select the deal.

5. The method of claim 1, further comprising receiving an estimate of a total number of impressions that are available to be allocated among the plural deals.

6. The method of claim 1, wherein said assigning comprises using a dynamic programming technique to generate the allocation information.

7. The method of claim 1, wherein said assigning results in obtaining maximum revenue from the plural deal-providing entities.

8. The method of claim 1, wherein said assigning comprises:
generating a maximum revenue value that reflects maximum revenue that can be obtained for a case in which there are m candidate deals and n impressions;
determining a set of deal allocation values that identify numbers of impressions assigned to the respective m candidate deals, for the n impressions; and
repeating said generating and determining for a successively larger numbers of candidate deals, until reaching a final number M of candidate deals and a final number N of impressions.

9. The method of claim 1, wherein said assigning is based on an assumption that each user will receive, at any given time, a single deal for consideration.

10. The method of claim 1, wherein said assigning is based on an assumption that each user will receive, at any given time, a single deal for consideration, and wherein said generating of the maximum revenue value is performing using a function ƒ(m, n), defined as:
ƒ(m,n)=max{ƒ(m−1,n),maxₓ₌ₗ_{ₘ}^{min{n,u}^{ₘ}^{}}(ƒ(m−1,n−x)+wₘx)},
where lₘ refers to a minimum number of purchases to be made in order for a discount associated with an m-th deal to apply, uₘ refers to a maximum number of purchases beyond which the m-th deal no longer applies, and wₘ refers to revenue that can be gained upon assigning x impressions to the m-th deal.

11. The method of claim 1, wherein said assigning is based on an assumption that each user will receive, at any given time, two or more deals for consideration.

12. The method of claim 11,
wherein said assigning is based on an assumption that, for each deal i, lᵢ=uᵢ, where lᵢ refers to a minimum number of purchases to be made in order for a discount associated with the deal to apply, and uᵢ refers to a maximum number of purchases beyond which the deal no longer applies,
further wherein said assigning involves successively determining a set of deal allocation values that identify numbers of impressions assigned to m candidate deals, for successively larger values of m,
further wherein said determining involves assessing the feasibility of each set of deal allocation values.

13. The method of claim 11,
further comprising using two or more slots to respectively present said two or more deals,
wherein each slot has a slot probability associated therewith which determines a probability of the slot being viewed by users, relative to other slots,
further wherein said assigning is based on an assumption that said two or more slots have the same slot probability,
further wherein said assigning comprises using a single-slot allocation technique to determine the allocation information.

14. The method of claim 11,
further comprising using two or more slots to respectively present said two or more deals,
wherein each slot has a slot probability associated therewith which determines a probability of the slot being viewed by users, relative to other slots,
further wherein said assigning is based on an assumption that said two or more slots have differing slot probabilities,
further wherein said assigning comprises breaking each deal into two or more component deal parts, and performing said assigning based on the deal parts.

15. A computer readable storage medium for storing computer readable instructions, the computer readable instructions implementing a deal allocation method when executed by one or more processing devices, the method comprising:
generating a maximum revenue value that reflects maximum revenue that can be obtained for a case in which there are m candidate deals and n impressions, each deal being triggered upon reaching a prescribed group-buying threshold;
determining a set of deal allocation values that identify numbers of impressions assigned to the respective m candidate deals for case of n impressions, a number of impressions for each deal describing a number of times that the deal will be presented to users; and
repeating said generating and determining for successively larger numbers of candidate deals, until reaching a total number M of candidate deals and a total number N of impressions,
where a current instance of said generating and determining uses results provided by a prior instance of said generating and determining.

16. The computer readable storage medium of claim 15, wherein the deal allocation method operates based on an assumption that each user will receive, at any given time, a single deal for consideration.

17. The computer readable storage medium of claim 15, wherein the deal allocation method operates based on an assumption that each user will receive, at any given time, two or more deals for consideration.

18. A group-buying system, implemented by computing functionality, for allocating deals to users, comprising:
a deal management system, comprising:
an interaction module configured to receive deal information from deal-providing entities via a network, the deal information describing plural deals, each deal being invoked when purchase activity associated with the deal reaches a prescribed threshold;
a data store for storing the deal information;
a deal allocation system, comprising:
an allocation module configured to use a dynamic programming technique to assign a number of impressions to each deal in a manner that maximizes a revenue value, to provide allocation information, the number of impressions for each deal describing a number of times that the deal will be presented to users; and
a data store for storing the allocation information; and
a deal presentation system configured to present at least one deal to users, based on the allocation information.

19. The group-buying system of claim 18, wherein the deal management system and the deal allocation system are configured to receive the deal information and generate the allocation information, respectively, in an automated manner.

20. The group-buying system of claim 18, wherein the allocation module comprises:
logic configured to generate a maximum revenue value that reflects maximum revenue that can be obtained for a case in which there are m candidate deals and n impressions;
logic configured to determine a set of deal allocation values that identify numbers of impressions assigned to the respective m candidate deals, with respect to the n impressions; and
wherein the allocation module is configured to repeatedly generate a maximum revenue value and a set of deal allocation values for successively larger numbers of candidate deals, until reaching a final number M of candidate deals and a final number N of impressions.
